(19) United States
(12) Patent Application Publication
(10) Pub. No.: US 2006/0148401 A1
(43) Pub. Date: Jul. 6, 2006

(54) Method and apparatus for enabling generation of a low error timing reference for a signal received via a repeater

(75) Inventors: Mike Roper, Ottawa (CA); Colin Kellett, Ramsbury (GB); Jie Zhang, Kanata (CA)

Correspondence Address: OGILVY RENAULT LLP, 1981 MCGILL COLLEGE AVENUE, SUITE 1600, MONTREAL, QC, H3A2Y3, CA

(73) Assignee: Spotwave Wireless Canada Inc., Katana (CA)

(21) Appl. No.: 11/291,846

(22) Filed: Dec. 2, 2005

Related U.S. Application Data
(60) Provisional application No. 60/632,264, filed on Dec. 2, 2004.

(51) Int. Cl. H04B 7/15

(52) U.S. Cl. 455/11.1

(57) ABSTRACT

Methods are provided for compensating the electrical path delay imposed on signals traversing a repeater. In some embodiments, the repeater generates an output signal having an undelayed signal component. Detection of the undelayed signal component enables establishment of a low error timing reference. In other embodiments, the repeater superimposes a low level signature onto signals traversing the repeater. The signature includes embedded information, from which a receiver can determine an accurate time reference.

### CROSS-REFERENCE TO RELATED APPLICATIONS

This is the first application filed for the present invention.

### MICROFICHE APPENDIX

Not Applicable.

### TECHNICAL FIELD

The present invention relates to determination of the location of a mobile station based on time of arrival (TOA), and in particular to methods and systems enabling generation of a low error timing reference for a signal received via a repeater.

### BACKGROUND OF THE INVENTION

Wireless network operators have a requirement to provide the capability to locate the position of a mobile station (such as a cellular handset, PDA etc.) making a call within the coverage area of the provider's network. Typically, the location of a mobile station is estimated by computing the relative time of arrival (TOA) of synchronization (or other readily identifiable) signals transmitted by the mobile station and received by multiple fixed stations of the wireless network. Representative examples of these techniques are described in U.S. Pat. Nos. 6,157,842 (Karlsson et al) and 6,665,333 (McCrady et al).

As shown in FIG. 1, in a conventional wireless network, a mobile station 2 transmits an uplink signal Su(t), which is received by multiple fixed stations 4. Each fixed station 4 implements conventional techniques for receiving the uplink signal Su(t), and generating a timing reference. In a spread spectrum network, for example, the received uplink signal Su(t) may be supplied to a rake receiver 6, which implements a set of parallel correlators (not shown) and uses the spreading code of the mobile station to detect its uplink signal Su(t). The detected uplink signal Su(t) is then passed to a digital filter 8, which removes multipath echoes to recover a clean signal 10 for further processing and/or retransmission

The rake receiver 6 also generates the timing reference 12, which corresponds to the timing of the first-arriving component (or echo) of the uplink signal Su(t). This “leading echo” is assumed to have arrived at the fixed station antenna via a direct path, in which case the set of timing references 12a-c generated by each of the fixed stations 4 provide an accurate indication of the relative distances between the mobile station 2 and each of the fixed stations 4a-c. Accordingly, the respective timing reference 12 generated by each fixed station 4 is transmitted to a central computer 14. When the central computer 14 receives timing references from at least three fixed stations 4, it can derive this relative distance information and determine the location of the mobile station 2.

In a Time Division Multiple Access (TDMA) system (such as GSM, EDGE etc.) an equivalent operation is performed, but in this case, the timing reference 12 is generated based on the time of arrival of a unique time reference or marker embedded in the TDMA frame.

A limitation of the above techniques is that it cannot accurately determine the location of the mobile station 2 when there is a repeater in the network between the mobile station 2 and some, but not all, of the fixed stations 4. The reason for this is described below with reference to FIG. 2.

Referring to FIG. 2, a conventional repeater 16 is shown positioned in the signal path between the mobile station 2 and a fixed station 4. The repeater 16 includes an uplink amplification block 18 coupled between a coverage antenna 20 and a donor antenna 22. The coverage antenna 20 receives an input signal Si(t) which includes the uplink signal Su(t) from the mobile station 2. The uplink amplification block 18 includes a cascade of amplifiers and filters (not shown in FIG. 2), all of which are known in the art. The amplifiers increase the signal power by a total gain of G_{IF}, which makes the repeater useful. The filters operate to prevent the unwanted amplification of signals outside the frequency band of interest, which improves repeater performance and reduces the transmission of spurious signals to the fixed station 4. However, the uplink amplification block 18 also imposes a time delay δ on signals traversing the repeater 16. Part of this delay is inherent to the amplification process, but it is primarily caused by the filters. Consequently, the uplink amplification block 18 generates an amplified and delayed signal G_{IF}Si(t-δ), which is transmitted through the donor antenna 22 to the fixed station 4a as an output signal So(t) The fixed station 4a operates in a normal manner to detect the uplink signal Su(t) within the repeater output signal So(t), and generate a respective timing reference 12a.

In some cases, the donor antenna 22 of the repeater 16 is a directional antenna, which transmits in a comparatively narrow beam. As a result, those fixed stations 4 lying within the antenna beam will receive the amplified and delayed signal G_{IF}Si(t-δ) from the repeater 16. For these fixed stations 4, because the uplink signal Su(t) is received via the repeater 16, the timing reference 12 inherently includes the repeater delay δ. On the other hand, at least some fixed stations 4 will receive the uplink signal Su(t) directly from the mobile station 2. For these fixed stations 4, because the uplink signal Su(t) is received directly from the mobile station 2, the timing reference 12 is unaffected by the repeater delay δ. Because this repeater delay δ affects the timing reference 12 of only some fixed station 4, but not all of them, it is seen by the central computer 14 as a timing reference error, which prevents accurate determination of the location of the mobile station 2.

In some networks, such as CDMA2000, the time of arrival calculation is performed in the mobile station 2, based on signals received from multiple fixed stations 4. In this case, the same errors can arise, where signals from some but not all of the fixed stations 4 are received via the repeater 16.

It should be noted that TOA-based systems are known in the art, including Differential Time of Arrival (DTOA) and Uplink Time Difference of Arrival (UTDOA). All of these systems rely on the establishment of the time reference or time stamp indicative of the time at which a signal transmitted by a mobile unit is received by a fixed station of the network. In addition, time of arrival information can be used as a secondary data input to other location systems, such as assisted GPS, which would therefore also be vulnerable to errors due to the electrical delay δ of a repeater. As such, all of these systems are considered to be fully equivalent for the purposes of the present application.

Accordingly, techniques enabling accurate estimation of mobile station location in wireless networks that include repeaters remain highly desirable.

### SUMMARY OF THE INVENTION

An aspect of the present invention provides a repeater of a wireless communications network. The repeater includes a first antenna for receiving an input signal from a first station of the wireless communications network. Means are provided for generating a substantially un-delayed signal component containing the input signal. A second antenna transmits at least the un-delayed signal component to a second station of the wireless communications network.

Another aspect of the present invention provides a method of estimating a location of a mobile station communicating with a fixed station of a wireless network via a repeater. An output signal transmitted by the repeater is received. The output signal includes at least an un-delayed signal component. A time reference is established using the un-delayed signal component.

A further aspect of the present invention provides a method of determining a location of a mobile station communicating with a fixed station of a wireless network via a repeater. An output signal transmitted by the repeater is received. The output signal includes a low level signature superimposed on signals traversing the repeater and uniquely associated with the repeater. The signature includes embedded information respecting the repeater. The embedded information is extracted from the signature. The location of the mobile station is determined using the embedded information.

A further aspect of the present invention provides a method of determining a location of a mobile station communicating with a wireless network via a distributed antenna system (DAS). An output signal is transmitted by an antenna of the DAS. The output signal includes a low level signature superimposed on signals traversing the DAS and uniquely associated with the antenna. The signature includes embedded information respecting the antenna. The embedded information is extracted from the signature. The location of the mobile station is determined using the embedded information.

It may be noted that each of the various aspects and features of the present invention may be used individually, or in combination, as desired.

### BRIEF DESCRIPTION OF THE DRAWINGS

Further features and advantages of the present invention will become apparent from the following detailed description, taken in combination with the appended drawings, in which:

FIG. 1 is a block diagram schematically illustrating a conventional wireless communications network for determining the location of a mobile station;

FIG. 2 is a block diagram schematically illustrating a conventional repeater in a signal path between a mobile station and a fixed station of the wireless communications network of FIG. 1;

FIGS. 3a and 3b are block diagrams respectively schematically illustrating two variants of a repeater in accordance with a first representative embodiments of the present invention;

FIGS. 4a and 4b are signal diagrams illustrating a typical distribution, as a function of time, of signal components in a signal received by a fixed station of the wireless network;

FIG. 5 is a block diagram schematically illustrating a repeater in accordance with a second representative embodiment of the present invention;

FIG. 6 is a block diagram schematically illustrating a repeater in accordance with a third representative embodiment of the present invention; and

FIG. 7 is a block diagram schematically illustrating a repeater in accordance with a fourth representative embodiment of the present invention.

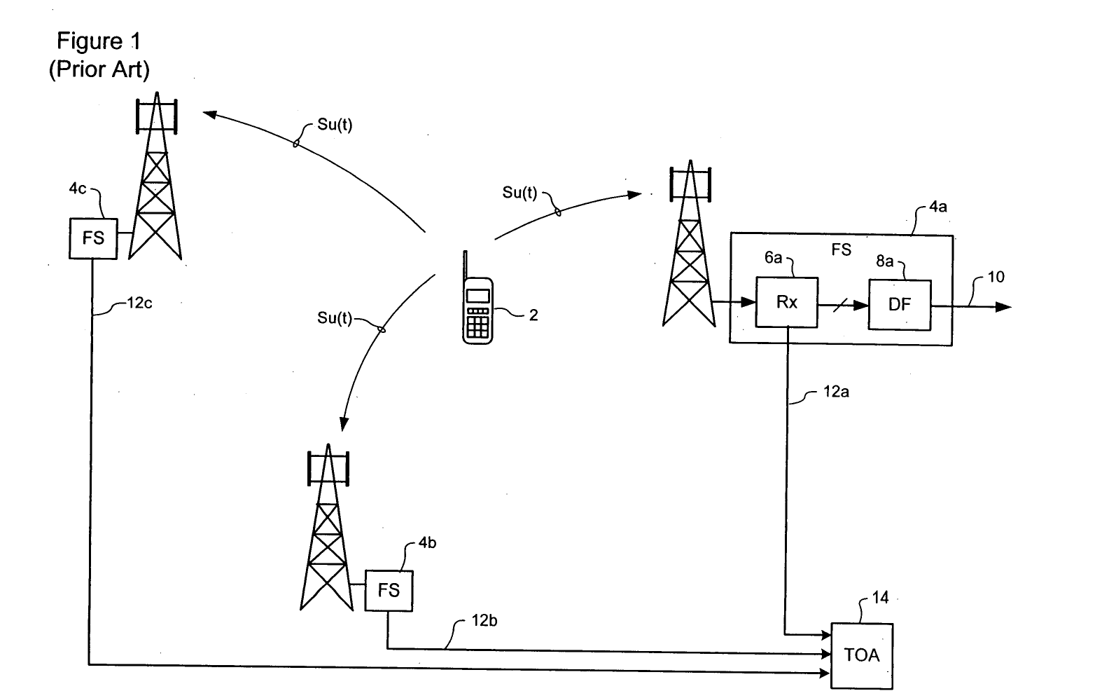

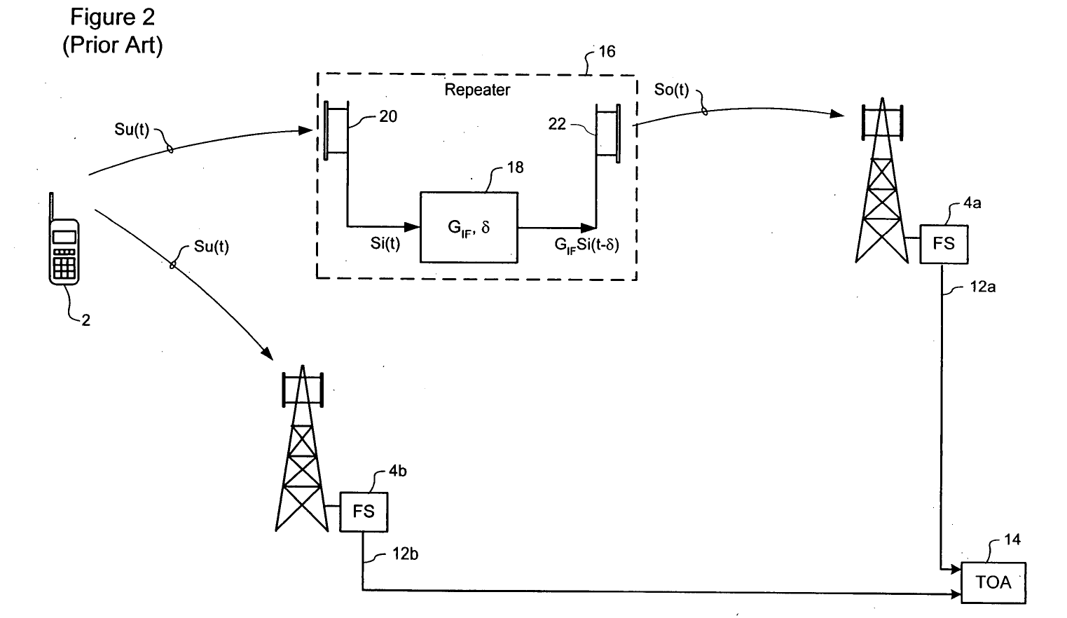

It will be noted that throughout the appended drawings, like features are identified by like reference numerals.

### DETAILED DESCRIPTION OF THE PREFERRED EMBODIMENT

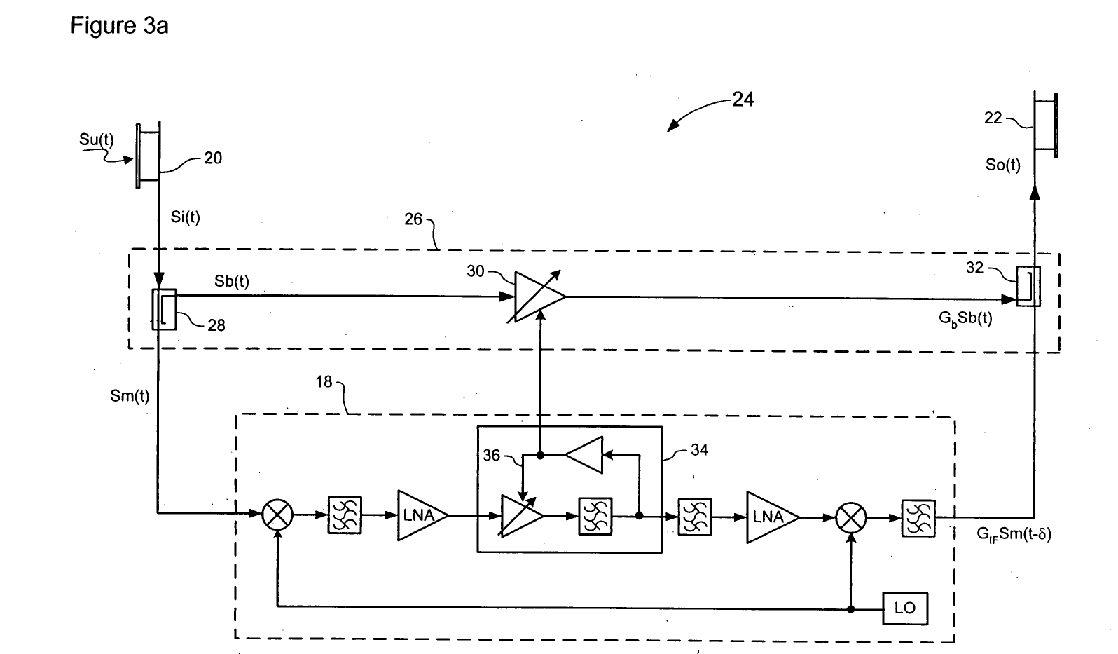

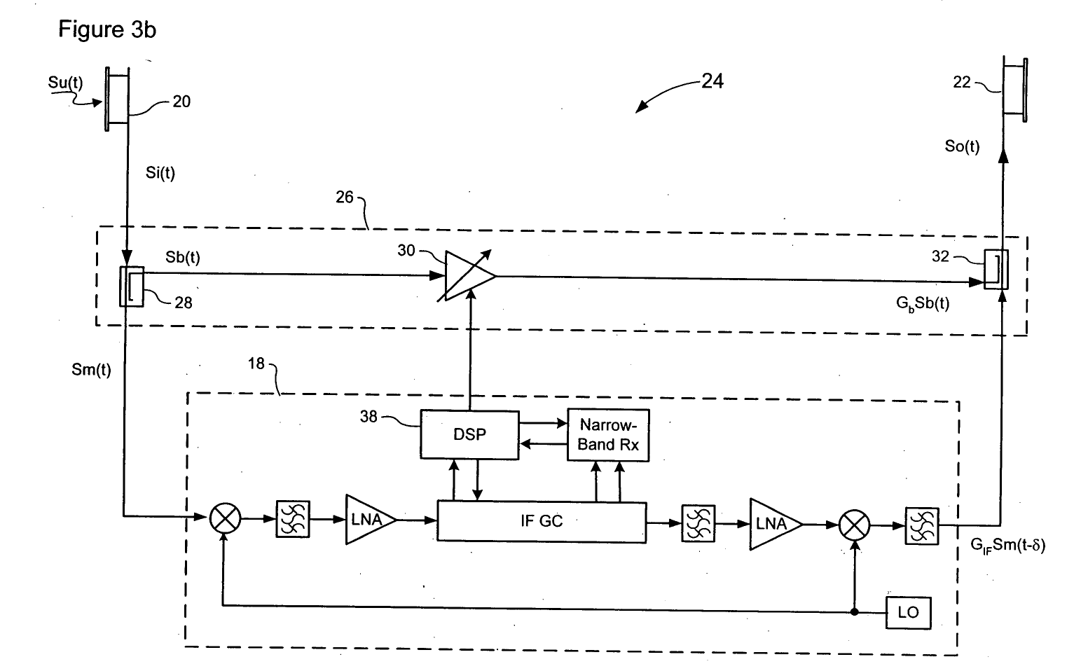

The present invention provides methods and systems which enable accurate estimation of the location of a mobile station in a wireless network which includes at least one repeater. Embodiments of the invention are described below with reference to FIGS. 3-7.

In general, the present invention operates by compensating the electrical path delay δ imposed on signals traversing a repeater. In the embodiments of FIGS. 3-5, this is accomplished by receiving an uplink signal Su(t) from a mobile station 2, and transmitting a substantially undelayed component (or echo) of the uplink signal Su(t) to the fixed station 4. With this arrangement, the fixed station 4 can establish a timing reference 12 based on the Time of Arrival (TOA) of the undelayed component, which greatly reduces location estimation errors due to the path delay δ of the repeater. In the following description, two methods of accomplishing this result are discussed.

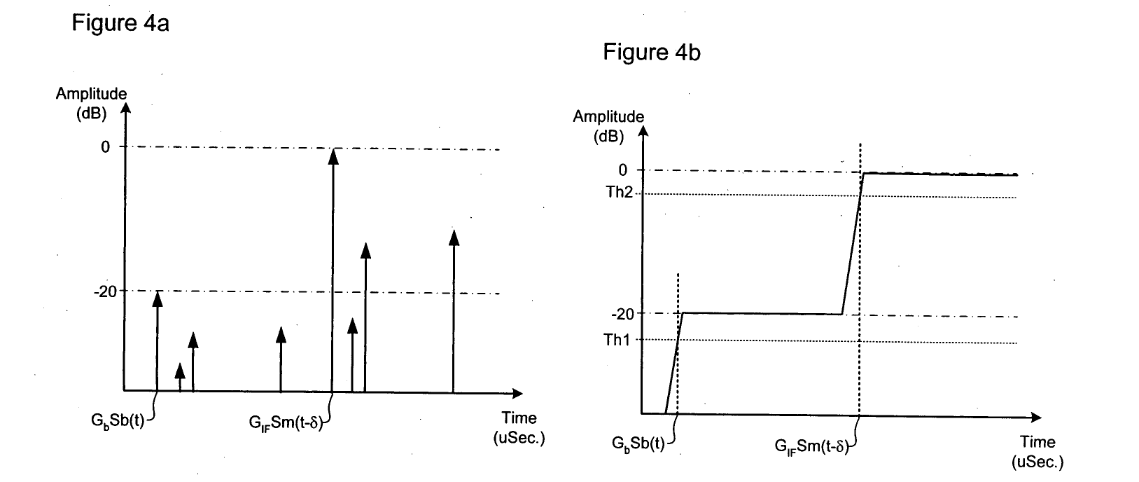

A first method is to use a bypass path to insert a low power, un-delayed “echo” of the uplink signal Su(t) in the output signal So(t) transmitted to the fixed station 4. In a CDMA network, for example, this un-delayed echo will then “capture” the fixed station's rake receiver 6 and be used to establish a low error timing reference 12. Representative embodiments of a repeater implementing this method are described with reference to FIGS. 3a and 3b. A second method is to selectively “switch out” the filters from the uplink amplification block 18 (thereby driving the repeater delay δ to close to zero) for a period of time long enough to enable the fixed station 4 to determine the timing reference 12. An embodiment of a repeater implementing this approach is described below with reference to FIG. 4.

As shown in FIG. 3a, a repeater 24 in accordance with a first embodiment of the present invention comprises a low-power bypass path 26 connected between the coverage and donor antennas 20, 22. In the illustrated embodiment, the bypass path 26 includes an input coupler 28, which divides the input signal Si(t) into a bypass signal Sb(t) and a main signal Sm(t) which traverses the conventional uplink amplification block 18; a variable gain amplifier/attenuator (VGA) 30 which enables the bypass path gain G_{b} to be varied; and an output coupler 32 which inserts the amplified bypass signal G_{b}Sb(t) into the output signal So(t). This arrangement enables the bypass path gain G_{b} to be varied with the uplink path gain G_{IF}. For example, in FIG. 3a, the uplink path gain G_{IF} is controlled by a conventional Automatic Gain Control (AGC) loop 34, so that the main signal G_{IF}Sm(t-δ) is transmitted at a substantially constant EIRP, independently of the power level of the received input signal Si(t). The conventional AGC gain control signal 36 can be tapped and used to control the bypass path VGA 30, so as to vary the bypass path gain G_{b} in direct proportion with the uplink path gain G_{IF}. With this arrangement, signals traversing the bypass path 26 can be amplified and transmitted with an EIRP 20-30 dB, for example, below that of signals of the main signal G_{IF}Sm(t-δ) generated by the uplink amplification block 18.

Because the bypass path 26 provides only simplified, broadband amplification, with no filtering, the bypass signal Sb(t) traverses the bypass path 26 with negligible electrical delay. Accordingly, the output signal So(t) transmitted by the donor antenna 22 will be a composite signal, made up of the low-level bypass signal G_{b}Sb(t), followed (at the path electrical delay δ) by the main signal G_{IF}Sm(t-6), as may be seen in FIG. 4a.

The amplified bypass signal G_{b}Sb(t) component appearing within the output signal So(t) is at a low level compared to the main signal G_{IF}Si(t-δ), for example 20 dB lower in level. At the fixed station 4, the bypass signal G_{b}Sb(t) and the main signal G_{IF}Si(t-δ) appear as multipath signal components (or echoes), separated in time by the path electrical delay δ. The fixed station 4 will also receive other multipath signals, due to reflections from objects along the signal path between the mobile station 2 and the fixed station 4. The delay and amplitude of these multipath components are primarily a function of the mobile device's position, and tend to vary rapidly as the mobile station 2 is moved within the coverage area of the repeater 24, and/or if there are any changes in the reflections created inside or outside the coverage area. A typical cause of the former type of variation is movement of people (and thus their mobile devices) inside the coverage area (e.g. inside a building). A typical cause of the latter type of variation is movement of vehicles located along the signal path. It is possible to distinguish the bypass signal G_{b}Sb(t) and the main signal G_{IF}Sm(t-δ) from the other multipath signals by exploiting the fact that the time difference (delay) between the bypass signal G_{b}Sb(t) and the main signal G_{IF}Sm(t-δ) is substantially fixed, whereas the time differences between the other multipath signals are rapidly time varying.

In some embodiments, the fixed station receiver 6 may be equipped with a system for resolving multipath components. A typical example of such a system is the rake receiver of a CDMA network base station. Such an arrangement allows the receiver to identify the earliest-arriving signal component, which is assumed to be the bypass signal G_{b}Sb(t), and provides the most accurate TOA information for the signal. If desired, the leading signal component may be used directly to provide a timing reference 12 for the mobile station 2. Alternatively the fixed station 4 may use the strongest signal (i.e. the main signal G_{IF}Sm(t-δ)) to establish the time reference 12, and then measure the time difference between it and the first component G_{b}Sb(t). The measured time difference can then be used to correct the time reference 12 based on the time of arrival of the strongest signal component. Because of the fixed time difference between the bypass signal G_{b}Sb(t) and the main signal G_{IF}Sm(t-δ), it is possible to resolve them in the presence of the other time-varying multipath components by using time-averaging techniques.

The resolution of multipath signals may be performed in several different ways. For example in a CDMA network, it will be appreciated that the low-level bypass signal G_{b}Sb(t) will be “seen” by a rake receiver 6 of the fixed station 4 as a leading echo of the main signal G_{IF}Si(t-δ), and thus can be used to directly establish the timing reference 12. Since the bypass signal G_{b}Sb(t) traverses the repeater 24 with negligible electrical delay, this timing reference 12 suffers virtually no error due to the presence of the repeater 24, and thus can be used for in conventional methods for TOA-based determination of the location of the mobile station 2.

In a time-multiplexed network (such as TDMA, GSM etc.), where rake receivers may not used to demodulate the signal, transmitters typically do not emit a continuous signal, but instead transmit data in discrete time-slots. In this type of network, the detection of the non-delayed component of the transmission from the mobile may be performed by using techniques based on the detection of the amplitude of the signal at the start of the transmission. As may be seen in FIG. 4b, the envelope of the received signal will initially rise as the non-delayed component G_{b}Sb(t) is received first at the fixed-station 4, followed by a second amplitude increase when the main component G_{IF}Sm(t-δ) arrives. The times of arrival of the leading and main signals can be determined by measuring the signal amplitude as it crosses predetermined thresholds that may, for example, be derived from the expected level of the main signal G_{IF}Sm(t-δ). This can be used to establish a time reference 12 from either the leading component or the main signal, as desired. Alternatively, the detected time of arrival of the leading component can be used to calculate an offset which corrects the time reference conventionally established on the basis of a marker embedded in the TDMA frame. As described above, the effect of other time-varying multi-path components on the accuracy of this method can be mitigated by averaging the data over a number of time slots.

It should be noted that, because of the lack of filters in the bypass path 26, the by-pass signal G_{b}Sb(t) will contain significant amounts of noise. However, in most cases, the signal-to-noise ratio of the bypass signal G_{b}Sb(t) will still be high enough to enable the fixed station 4 to detect the uplink signal Su(t) and establish the timing reference 12. At the same time, the low level of the bypass signal (e.g. 20-30 dB below the main signal) ensures that the noise level within the composite output signal So(t) is well within the noise tolerance of the fixed station 4, and thus will not disrupt communications.

FIG. 3b shows an alternative embodiment, in which the gain G_{IF} of the uplink amplification block 18 is controlled by a micro-controller 38 operating under software control. Representative repeaters of this type are known, for example, for applicant's co-pending and co-assigned U.S. patent application Ser. No. 10/359,096 published on Aug. 12, 2004.

The embodiment of FIG. 3b is similar to that of FIG. 3a, in that the bypass path 26 generates a bypass signal G_{b}Sb(t) with a negligible electrical delay. This bypass signal appears in the output signal So(t) transmitted by the repeater 24 as a substantially un-delayed “leading echo”, which is used by the fixed receiver 4 to establish a low-error timing reference 12 for TOA calculations. In this case, however, the micro-controller 38 operates under software control to govern the by-pass path gain G_{b}, which can therefore have any desired relationship to the uplink path gain G_{IF}.

For example, the micro-controller 38 can be programmed to detect the start of signal transmission (i.e. the beginning of a call) from the mobile station 2. When this occurs, the micro-controller 38 can increase the by-pass path gain G_{b}, so as to ensure that the fixed station 4 receives the bypass signal G_{b}Si(t) and uses it for establishing a low-error timing reference 12. Thereafter, the micro-controller 38 can reduce the by-pass path gain G_{b} to avoid transmitting excessive noise to the fixed station 4. This operation exploits the fact that most conventional wireless networks determine the location of the mobile station 2 within the first 30-45 seconds of a call. As a result, it is only necessary to ensure that the fixed station 4 receives the un-delayed bypass signal G_{b}Sb(t) during this initial period of a call. Afterwards, the by-pass path gain G_{b} can be reduced to any desired level, even to the point of completely suppressing the bypass signal G_{b}Sb(t).

Those of ordinary skill in the art will appreciate that there are many ways of implementing this functionality, depending on the capabilities of the micro-controller 38 and the sophistication of the controlling software. For example, it is a relatively simple matter to detect the beginning of a call from the mobile station 2, by monitoring the power level of the input signal Si(t) received by the coverage antenna 20. Thus a simple, low-cost micro-controller 38 can use this information to hold the by-pass path gain G_{b} at a low level for normal operation, increasing it only during the first 30-45 seconds of each call to enable the fixed station 4 to establish a low-error timing reference. A more sophisticated system can be programmed to determine whether or not the call is an emergency call. In this case, the by-pass path gain G_{b} is increased only when the establishment of a low-error timing reference 12 is essential.

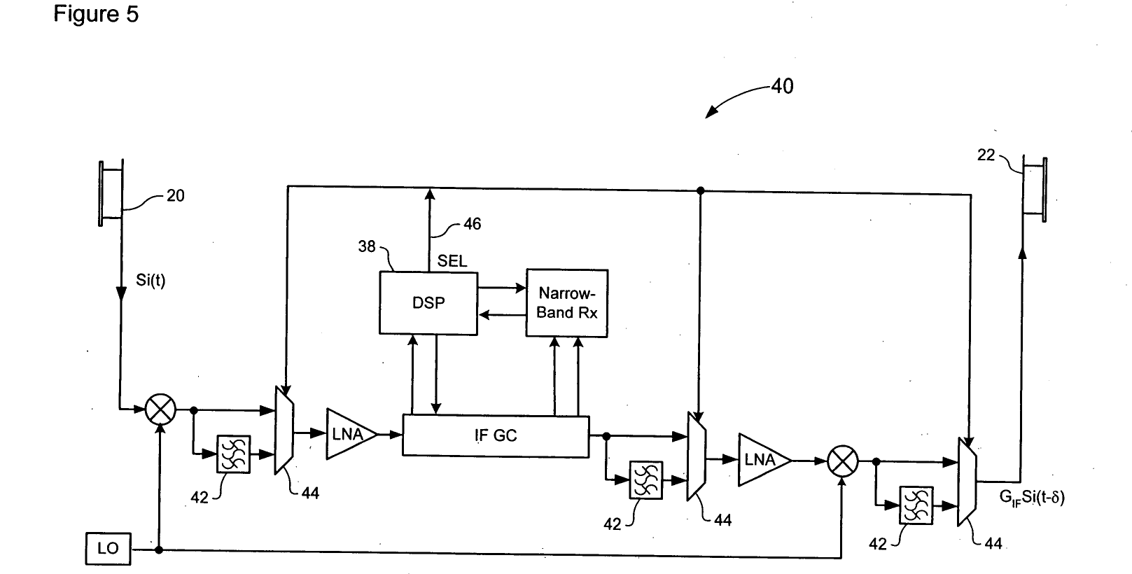

FIG. 5 shows a repeater 40 according to an embodiment in which the establishment of a low error time reference is enabled by switching-out the filters of the uplink amplification block 18. In the illustrated embodiment, each filter 42 of the amplification block 18 is cascaded with a respective selector switch 44 controlled by a “select” signal 46 generated by the micro-controller 38. With this arrangement, the micro-controller 38 can selectively bypass the filters 42 of the uplink amplification block 18, thereby generating a substantially un-delayed output signal G_{IF}Si (t) which can be used by the fixed station 4 to establish a low error timing reference 12. This embodiment may operate in a manner similar to that of FIG. 3b, in that the micro-controller 38 can detect the beginning of a call from the mobile station 2, and control the selector switches 44 to “switch-out” the filters 42 for the first part of that call (e.g. the first 30-45 seconds). This decreases signal-to-noise ratio of the output signal G_{IF}Si(t-δ), but reduces the path delay δ to a negligible value. As a result, the fixed station 4 receives the uplink signal Su(t) with negligible path delay δ, and can thus establish a low-error timing reference 12. After a period of time sufficient to enable the wireless network to determine the location of the mobile station 2 (e.g. 30-45 seconds), the micro-controller 38 can control the selector switches 44 to “switch in” the filters 42, so as to avoid transmitting spurious signals to the fixed station 4.

In the embodiments described above with reference to FIGS. 3-5, the time reference is established at the fixed station 4 based on the time or arrival of signals received from the mobile station 2. However, it will be appreciated that the same functionality can equally be implemented in the downlink direction. In this case, the methods illustrated in FIGS. 3 and 5 are implemented in the downlink path (not shown) of the repeater, so as to provide a substantially un-delayed component of the downlink signal received by the mobile station 2. The receiver of the mobile station 2 can then implement the methods described above (in respect of the fixed station 4) to establish a time reference for the received signals. This function can repeated for signals received from a plurality of fixed stations, and the resulting set of time references (or location information derived from the time references) subsequently transmitted to the fixed station 4 or the central computer 14 using a messaging protocol supported by the network, such as a control channel or short message service (SMS).

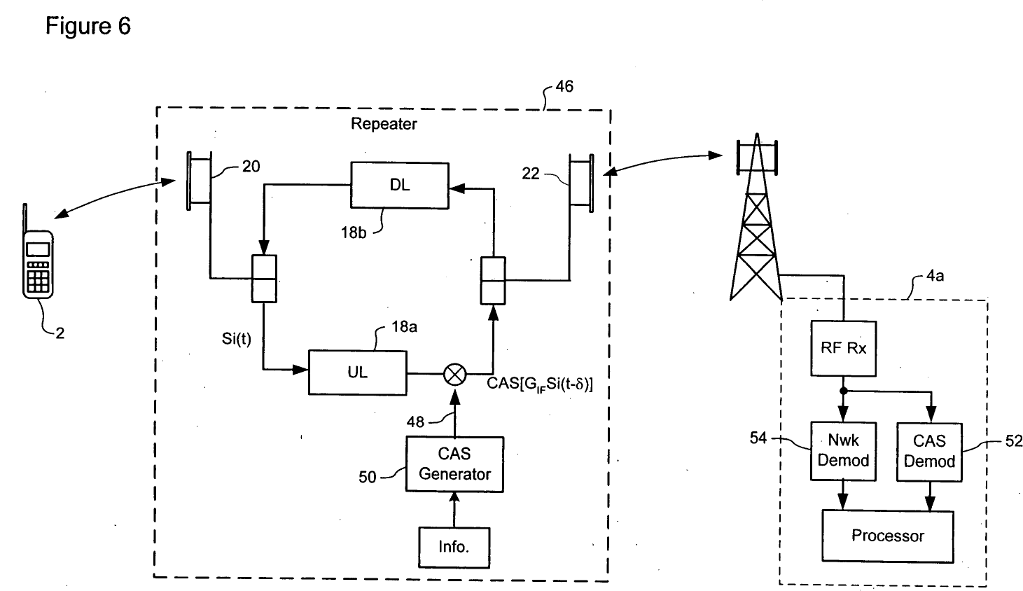

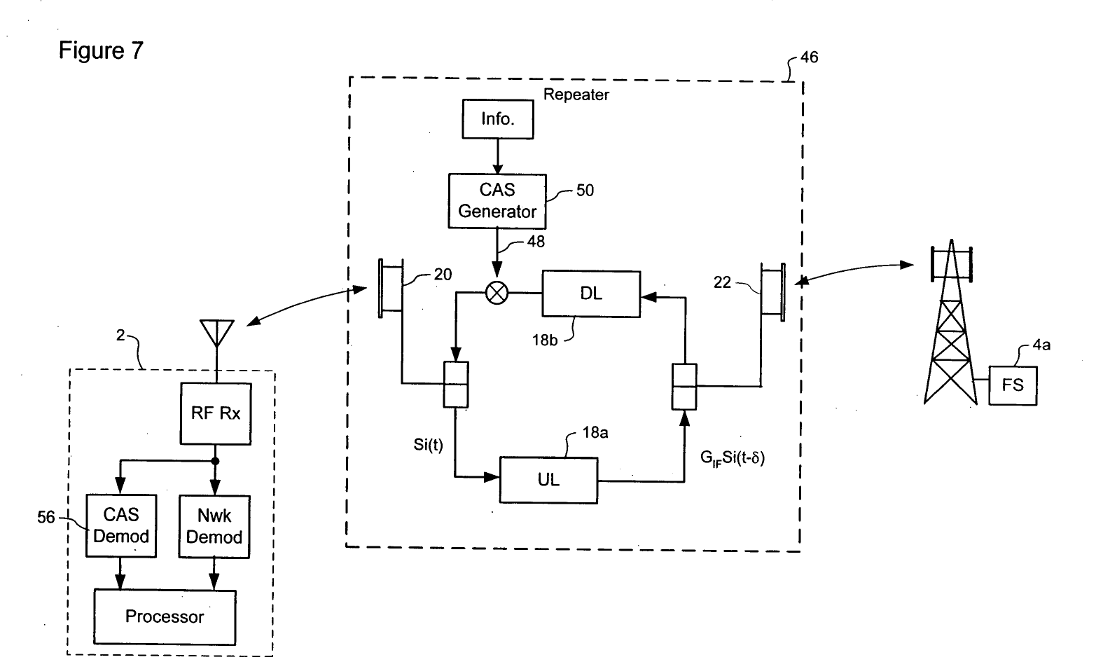

In the embodiments described above with reference to FIGS. 3-5, compensation of the electrical path delay δ of the repeater is accomplished by supplying a substantially undelayed “leading echo” to the fixed station 4. FIGS. 6 and 7 illustrate an alternative method, in which compensation of the electrical path delay δ of the repeater is accomplished by means of a low level signature superimposed on signals traversing the repeater.

Signature signals are known from Applicant's U.S. Pat. No. 6,899,033, and applicant's co-pending and co-assigned U.S. patent applications Ser. Nos. 09/919,888 and 10/359,096. In general, the signature signal is provided as a low-level broadband amplitude and/or phase modulation superimposed on signals traversing the repeater. In some cases, the signature is provided as a series of tone pulses, while in other cases it is provided as a Pseudo-random number (PN) code. In all cases, the signature is uniquely associated with a specific repeater, at least within the local region in which the repeater is installed. The signature repeats at a predetermined rate, which is normally selected as a balance between cost and response time. The signature waveform is designed to ensure that the signature will not interfere with data communications between the mobile station 2 and fixed station 4. Thus, for example, the signature may be designed to be “seen” by a conventional receiver as a low level fade due to multi-path or device movement, or as low level noise. In either case, the low power level (e.g. 20-30 dB below the main signal level) of the signature ensures that the receivers in the fixed station 4 and the mobile station 2 filter out the signature, which ensures that the signature does not impair communications quality. However, as described in Applicant's U.S. Pat. No. 6,899,033, and applicant's co-pending and co-assigned U.S. patent applications Ser. Nos. 09/919,888 and 10/359,096, the signature is detectable using known correlation techniques, and can be used to manage stability of the repeater, for example.

The embodiments of FIGS. 6 and 7 exploit the fact that the signature rides on the regular signal traffic without interfering with communications, but is still detectable, to enable compensation of the electrical delay δ. In general, this is accomplished by modifying the signature to include embedded information that can be used to improve location estimation. Various different types of embedded information may be used for this purpose, including, but not limited to:
The uplink and/or downlink path electrical delays δ of the repeater, or equivalent, which can be used as an offset to the time reference determined by the fixed station 4. This enables the fixed station 4 to directly compensate electrical delay δ of the repeater, and so improve TOA-based location estimation, without need for any additional information or time-of arrival measurements;
an installed location of the repeater and/or its coverage area, such as for example: geographical coordinates; street address and floor number etc. This information can be used to resolve ambiguities in the TOA-based location estimate, and/or enable location determination based solely on the location of the repeater.
A repeater identifier that uniquely identifies the repeater. The repeater identifier may, for example, be a manufacturer's serial number, or the PN code (or a portion of it) assigned to the repeater for its singature-based stability management functions. Based on the repeater ID, the fixed station 4 and/or the central computer 14 can. obtain (e.g. via a table look-up) additional information about the repeater which may, for example, include any of the uplink path electrical delay δ and installed location information described above.

Preferably, the embedded information is designed to start at a predetermined location relative to the beginning of a signature. For example, consider an embodiment in which the signature is an encoded bit sequence, such as a PN code. In such cases, the embedded information should preferably start at a predetermined bit offset relative the start of the PN code. In the case of a tone based signature, the embedded information can be added to the signature by such means as on-off keying, or using different tones (frequencies) to represent symbols. In either case, the data is re-transmitted with a repetition rate that will allow the data to be extracted from the signature within typically one second of a mobile transmission back to the fixed station 4.

The specific information to be embedded within the signature may be supplied to the repeater 46 in a variety of ways. For example the repeater type, serial number, or its characteristic delay δ, can be loaded into the repeater 46 at the time of manufacture either as a code stored in non volatile memory or by setting a number of switches. Information that is specific to a particular repeater location, such as the latitude and longitude co-ordinates, or a street address of building floor number may more conveniently be loaded into the repeater 46 when it is installed. This can be done by programming the repeater 46 via a data connection from a portable computer or programming device, or by inserting a personality module (not shown) which is pre-configured with the appropriate information. In each case, the data should be stored in non-volatile memory, so that it is not lost during a power outage, for example.

As may be appreciated, various methods may be implemented to detect the signature in signals received from the repeater 46. For example, a signature detector can exploit the fact that the signature, and thus any embedded information, repeats at a known rate. As such, conventional autocorrelation techniques and data averaging over a number of recieved signature bursts can be used to isolate the signature from a received signal. Once the signature has been isolated, it is a simple matter to extract the embedded information for further processing. FIGS. 6 and 7 illustrate two alternative embodiments in which this functionality is implemented.

In the embodiment of FIG. 6, a signature 48 output by a signature generator 50 is imposed on the uplink signal traversing the uplink amplification block 18, and transmitted to the fixed station 4 as part of the output signal So. With this arrangement, the fixed station 4 will receive the signature whenever a mobile station 2 within the coverage area of the repeater 46 is transmitting. As may be seen in FIG. 6, in order to detect the signature, the fixed station 4 is provided with a signature detector 52, which may be implemented in any suitable combination of hardware and/or software. The signature detector 52 preferably operates in parallel with the conventional signal path 54, so as to avoid interfering with data communications. By suitably controlling the signature detector 52, it is possible to detect the respective sigature from every signature-capable repeater 46 operating in the fixed station's coverage area. Each detected Sigature can then be processed to extract its embedded information.

As will be appreciated, the arrangement of FIG. 6 can result in the fixed station 4 detecting multiple signatures; one from each of a plurality of repeaters 46 operating in its coverage area. If the electrical delays of these repeaters vary markedly from one another, accurate location estimation will depend on the fixed station 4 being able to correctly associate each received uplink signal Su(t) with the repeater 46 through which it was received. Because the signature is superimposed uniformly on all signals traversing the repeater, the fixed station 4 can detect and extract the signature from the respective receiver assigned to any particular mobile station 2 from which it is receiving a signal. Depending on the construction of the fixed station 4, and the number and design of the repeaters 46 operating in its coverage area, this may be costly to implement. The embodiment of FIG. 7 overcomes this difficulty by inserting the signature onto downlink signals transmitted by the repeater 46 into it's coverage area.

As may be seen in FIG. 7, this arrangement requires that the mobile station 2 be provided with a signature detector 56, which implements correlation techniques to detect the signature, as described above. However, since the mobile station 2 will normally be operating in the coverage area of exactly one repeater 46 (or none at all) at any given time, it is only necessary for the signature detector 56 to be able to detect one signature in the downlink signals received by the mobile station 2. This greatly reduces size, complexity, cost and power requirements of the signature detector 56. Once the signature has been detected, it can be transmitted to the fixed station 4 (or the central computer 14) using a known messaging protocol already supported by the network such as, for example, a control channel or short messaging service (SMS). Alternatively, the mobile station 2 may be programmed to extract the embedded information from the signature, so that only the embedded information is transmitted. In either case, the fixed station 4 (or central computer 14) can readily identify the specific repeater through which uplink signals from the mobile station 2 have been received. This enables the correct information to be associated with the received uplink signals, so that the location of the mobile station 2 can be accurately estimated.

In a repeater system with multiple coverage antennas 20, such as a distributed antenna system or DAS, a different signature may be transmitted from each antenna. By using PN sequences with low cross correlation at each antenna, this method can be used to determine the isolation available from each antenna in the DAS system, and to adapt the gain at each antenna accordingly. This type of system may therefore be referred to as an Adaptive DAS system (ADAS). If a mobile station 2 is located in the coverage area of such an ADAS system, the signature detector 56 in the mobile station 2 can determine which is the strongest downlink signal (i.e. the dominant code), and extract position information from that particular code. In this configuration the mobile station 2 can thus determine its proximity to a specific coverage antenna 20 in the DAS. In a multi-level building served by an ADAS system, with different coverage antennas located on each floor, it is therefore possible to determine which floor of the building the mobile station 2 is on, if each coverage antenna 20 transmits its own embedded information (position data) to the mobile.

In ADAS system, uplink signals are generally combined into a single donor antenna 22 for transmission back to the base-station. For simplicity, and to avoid distortion, a single signature is normally superimposed in this direction on the combined uplink signals, so that the coverage antennas 20 may not be individually identified from the signature. However the mobile station 2 may transmit the coverage antenna position information, decoded from the downlink signatures, back to the network using a normal network data transmission, for example using a short message service (SMS).

As mentioned above, various different types of information may be embedded in the signature. Where the embedded information identifies the location of the repeater, or its coverage area, the location of the mobile unit 2 can be determined without triangulation. In the case of an ADAS system, each of the coverage antennas may be provided with its own signature, and embedded location information identifying the location of the antenna (or its respective portion of the ADAS' coverage area). With this arrangement, it is not necessary to transmit the location information through a wireless link to the fixed station 4. An example of this arrangement is where a “captive” base station is coupled directly to the ADAS system.

The embodiment(s) of the invention described above is(are) intended to be exemplary only. The scope of the invention is therefore intended to be limited solely by the scope of the appended claims.

We claim:

1. A repeater of a wireless communications network, the repeater comprising:
a first antenna for receiving an input signal from a first station of the wireless communications network;
means for generating a substantially un-delayed signal component containing the input signal; and
a second antenna for transmitting at least the un-delayed signal component to a second station of the wireless communications network.

2. A repeater as claimed in claim 1, wherein the means for generating a substantially un-delayed signal component comprises a by-pass path connected between the first and second antennas of the repeater.

3. A repeater as claimed in claim 2, wherein the by-pass path comprises a variable gain amplifier/attenuator (VGA) for controlling a gain G_{b} of the by-pass path.

4. A repeater as claimed in claim 3, wherein the VGA is controlled by a gain control signal generated by an automatic gain controller (AGC) of an amplifier block, so as to maintain a predetermined relationship between a gain G_{b} of the by-pass path and a path gain G_{IF} of the amplifier block.

5. A repeater as claimed in claim 3, wherein the VGA is controlled by a gain control signal generated by a micro-controller.

6. A repeater as claimed in claim 5, wherein the micro-controller operates under software control to increase the gain G_{b} of the bypass path during an initial portion of a call initiated by the first station.

7. A repeater as claimed in claim 1, wherein the means for generating a substantially un-delayed signal component comprises at least one selector switch controllable to selectively switch-out at least one filter of the repeater.

8. A method of estimating a location of a mobile station communicating with a fixed station of a wireless network via a repeater, the method comprising steps of:
receiving an output signal transmitted by the repeater, the output signal including at least an un-delayed signal component; and
establishing a time reference using the un-delayed signal component.

9. A method as claimed in claim 8, wherein the step of establishing a time reference comprises steps of:
detecting a time of arrival (TOA) of the un-delayed signal component; and
establishing the time reference based on the detected TOA.

10. A method as claimed in claim 8, wherein the output signal further includes a delayed main signal component, and wherein the step of establishing a time reference comprises steps of:
detecting a time of arrival (TOA) of the un-delayed signal component;
detecting a time of arrival (TOA) of the delayed main signal component; and
calculating a time difference between the respective times of arrival of the un-delayed and delayed signal components.

11. A method of determining a location of a mobile station communicating with a fixed station of a wireless network via a repeater, the method comprising steps of:
receiving an output signal transmitted by the repeater, the output signal including a low level signature superimposed on signals traversing the repeater and uniquely associated with the repeater, the signature including embedded information respecting the repeater;
extracting the embedded information from the signature; and
determining the location of the mobile station using the embedded information.

12. A method as claimed in claim 11, wherein the embedded information comprises a repeater identifier of the repeater.

13. A method as claimed in claim 12, wherein the repeater identifier comprises any one or more of:
a serial number;
a model number; and
a pseudo-random number (PN) code assigned to the repeater.

14. A method as claimed in claim 12, wherein the step of determining the location of the mobile station comprises a step of using the repeater identifier to query a database containing any one or more of
an electrical delay of the repeater;
an installed location of the repeater.

15. A method as claimed in claim 11, wherein the embedded information comprises any one or more of:
an electrical delay of the repeater;
an installed location of the repeater.

16. A method as claimed in claim 11, wherein the steps of receiving the output signal transmitted by the repeater and extracting the embedded information from the signature signal are performed by the mobile station, and wherein the step of determining the location of the mobile station comprises a step of transmitting the embedded information to either one of the fixed station or a central system.

17. A method of determining a location of a mobile station communicating with a wireless network via a distributed antenna system (DAS), the method comprising steps of:
receiving an output signal transmitted by an antenna of the DAS, the output signal including a low level signature superimposed on signals traversing the DAS and uniquely associated with the antenna, the signature signal including embedded information respecting the antenna;
extracting the embedded information from the signature; and
determining the location of the mobile station using the embedded information.

18. A method as claimed in claim 17, wherein the embedded information comprises an installed location of the antenna.

19. A method as claimed in claim 17, wherein the step of determining the location of the mobile station comprises a step of transmitting the embedded information to a fixed station of the wireless communication network.
